(19) United States
(12) Patent Application Publication
(10) Pub. No.: US 2006/0203343 A1
(43) Pub. Date: Sep. 14, 2006

(54) Retro-reflective device

(76) Inventors: Mark Modilevsky, Vernon Hills, IL (US); Ilya Kremnevskiy, Buffalo Grove, IL (US); Paul Klyachman, Northbrook, IL (US)

Correspondence Address: GREER, BURNS & CRAIN, 300 S WACKER DR, 25TH FLOOR, CHICAGO, IL, 60606, US

(21) Appl. No.: 11/077,300

(22) Filed: Mar. 10, 2005

(51) Int. Cl. G02B 5/12

(52) U.S. Cl. 359/515; 359/520

(57) ABSTRACT

A retro-reflective device that includes at least one relatively rigid backing member with a receiving portion shaped like at least a portion of a cylinder of a substantially uniform diameter; and at least one retro-reflective element having a retro-reflecting surface facing outwardly and a rear surface facing inwardly. Preferably, the rear surface of the retro-reflecting element is attached to the receiving portion of at least one backing member. Further, the retro-reflecting surface of the at least one retro-reflective element is at least partially approximately cylinder-shaped.

The present invention relates generally to a retro-reflective device, and more particularly to a retro-reflective device, or system of devices, in which the retro-reflecting surface is generally cylindrically-shaped, or is generally shaped as an arcuate portion of a cylinder.

### BACKGROUND OF THE INVENTION

Various types of retro-reflectors are known in the art. For example, flat faced retro-reflectors are know to be attached to the front and rear portions of bicycles, as well as to the wheels. One problem with such devices is that although such devices adequately reflect an automobile headlight back to the driver of the automobile when the headlight, and automobile driver, are perpendicular to the flat face of the retro-reflector (or within the angular range of observation), little or no light is reflected back to automobile driver when driver is located at angles outside of the angular range of observation. Accordingly, the driver may have little or no indication of the presence of a bicyclist, which creates a dangerous condition for both the cyclist and the driver.

Other flat-faced retro-reflective devices, such as those provided on highway surfaces, on roadsides, or on various types of vehicles, also only provide limited (or negligible) effectiveness when the observer cannot detect the reflected light impinging upon them because the observer is not located within the angular range of observation with respect to the flat face of the reflector.

Accordingly, it would be beneficial to provide a retro-reflective device whose effectiveness is maintained while the observer is positioned at a wider variety of different locations with respect to the device.

### BRIEF SUMMARY OF THE INVENTION

Briefly, one embodiment of the present invention provides a retro-reflective device that includes at least one relatively rigid backing member with a receiving portion shaped like at least a portion of a cylinder of a substantially uniform diameter; and at least one retro-reflective element having a retro-reflecting surface facing outwardly and a rear surface facing inwardly. Preferably, the rear surface of the retro-reflecting element is attached to the receiving portion of at least one backing member. Further, the retro-reflecting surface of the at least one retro-reflective element is at least partially approximately cylinder-shaped.

The present invention also relates to a system of retro-reflective segments for use as a retro-reflective device. In one embodiment, the system includes a plurality of relatively rigid backing members and a plurality of retro-reflective elements. Each of the backing members preferably includes a receiving portion shaped like at least a portion of a cylinder of a substantially uniform diameter, and each of the retro-reflective elements has a retro-reflecting surface facing outwardly. Additionally, each of the retro-reflective elements is attached to the receiving portion of one of the backing members. Further, the plurality of backing members are configured and arranged to be attached to each other such that an effective retro-reflecting surface defined by one or more of the retro-reflective elements forms at least a portion of an approximately cylindrical-shaped surface.

### BRIEF DESCRIPTION OF THE SEVERAL VIEWS OF THE DRAWINGS

Preferred embodiments of the present invention are described herein with reference to the drawings wherein:

FIG. 1 depicts one embodiment of the present retro-reflective device, which is in the form of an insert;

FIG. 2 shows the retro-reflective insert of FIG. 1 in exploded view being inserted into a cylindrical tube;

FIG. 3 depicts another embodiment of the present invention, which is in the form of an insert suitable to be inserted into a hollow tube of square cross-section;

FIG. 4 shows the retro-reflective insert of FIG. 3 in exploded view being inserted into a tube of square cross-section;

FIG. 5 depicts an embodiment of the present invention configured to be mounted upon a flat surface;

FIG. 6 depicts an embodiment of the present invention configured to be mounted to an interior corner;

FIG. 7 depicts an embodiment of the present invention configured to be mounted upon an exterior corner;

FIG. 8 depicts an embodiment of the present invention configured to be mounted on the outside of a cylindrical shaft; and

FIG. 9 depicts an embodiment of the present invention configured to be mounted upon a shaft of square cross-section.

### DETAILED DESCRIPTION OF THE INVENTION

The present invention can take many different forms, as described more fully below. Briefly, for example, one form of the invention is an insert with a cylindrical retro-reflective element attached thereto, where the insert is configured to be inserted into a hollow tube (such as that found on the ends of an automobile bicycle rack or bicycle handlebars). Another form of the invention relates to a cylindrical, or partially-cylindrical, retro-reflective element that is attached to a relatively rigid backing member. Such a device can be used, for example, in the following different ways: as a highway marker when it is partially embedded into the highway surface; as a roadside marker when attached to a vertical pole; as an indictor for indicating the location of a wall or corner; etc. Still another form of the invention relates to a cylindrical retro-reflective element, with a relatively rigid backing member, that is divided into a two or more arcuate segments so that it can be attached to surround a bar (such as a bicycle handlebar; a stroller handlebar; a truck's rear view mirror attachment bar, etc.). Of course, all of the different forms of the present invention can be made of any color or size, depending upon the desired application. Although the invention can take many forms, as will be shown and discussed below, one common feature of all embodiments is the inclusion of a cylindrical or partially cylindrical retro-reflective element so that light can be reflected back towards an observer located at a variety of different angles with respect to the device.

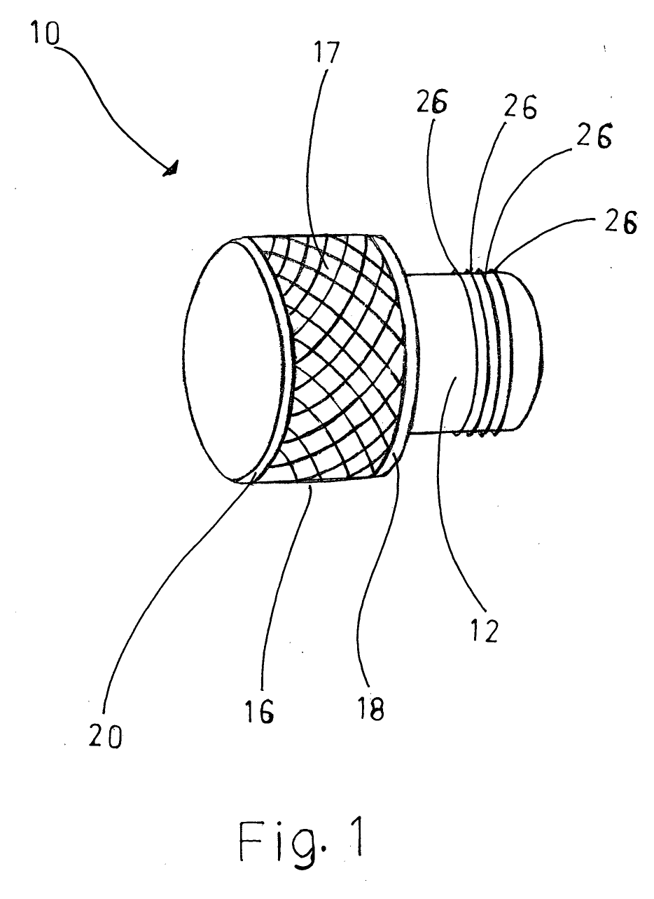

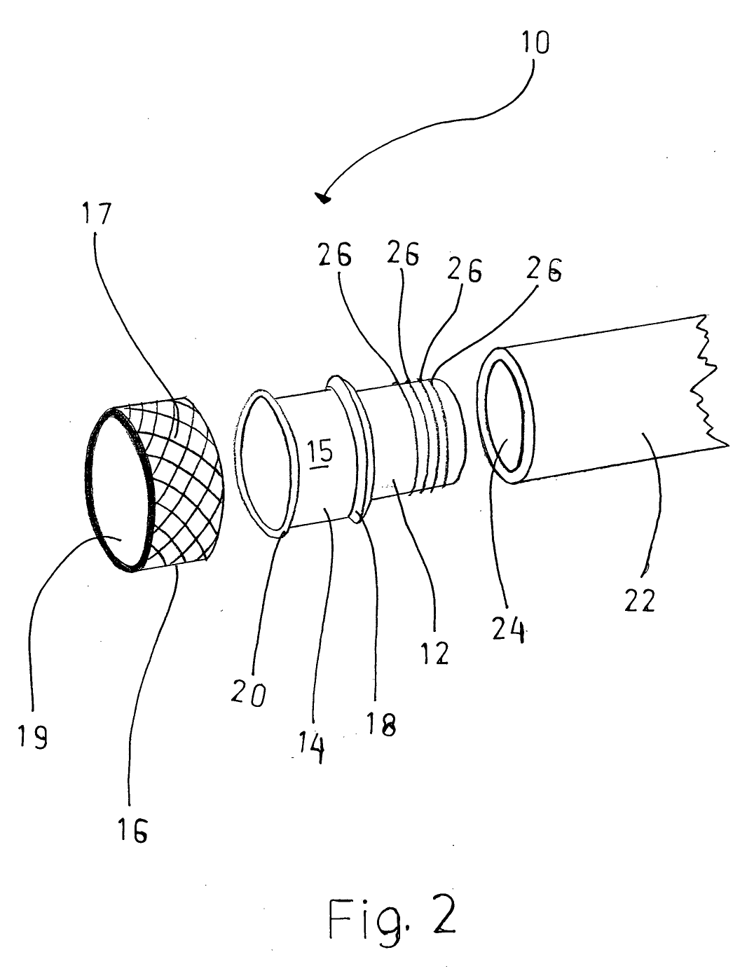

Referring now to FIGS. 1 and 2, one example of an embodiment of the present invention is shown. FIG. 1 depicts an insert 10 that is preferably made of a relatively rigid material such as rubber (or other similar elastomeric material), a plastic or a metal. As best shown in FIG. 2, the insert 10 includes an attachment portion 12, for attaching the insert to another component, and a relatively rigid backing member 14. The backing member includes a receiving portion 15 (as shown in FIG. 2) shaped, in this embodiment, like a cylinder of substantially uniform diameter.

The insert 10 also includes a retro-reflective element 16. The retro-reflective element 16 includes a retro-reflecting surface 17 facing outwardly and a rear surface 19 facing inwardly. The rear surface 19 of the retro-reflective element 16 is preferably attached to the outer periphery (i.e., the receiving portion 15) of the backing member 14 by an adhesive or other suitable attachment means. Alternatively, or in addition to the adhesive, the retro-reflective element 16 may be attached to the backing member 14 via a press-fit, or it may be secured in position by the pair of optional lips 18, 20. When considering the lips 18, 20, the axial length of the backing member 14 is greater than the corresponding axial length of retro-reflective element 16. However, if the lips are omitted, the backing member may be of a length approximately equal to the corresponding axial length of the retro-reflective element 16.

The backing member 14 may be substantially solid. Alternatively, the backing member may optionally include an axially extending hollow portion located radially interiorly of the receiving portion 15. Such a hollow portion may facilitate installation of the retro-reflective element 16 upon the backing member 14 by allowing the backing member 14 to slightly compress while the retro-reflective element 16 is attached thereto.

The retro-reflective element 16, and the retro-reflecting surface 17, are each preferably a full cylinder, as shown in FIGS. 1 and 2, which will enable surface 17 to reflect light towards an observer located at any angle from the retro-reflective element 16. However, it is also contemplated that the retro-reflective surface 17, and/or the retro-reflective element 16, could be formed as only a portion of a cylinder, such as half a cylinder, or any other desired arcuate portion of a cylinder greater than zero degrees but less than three hundred sixty degrees. Similarly, if the retro-reflective element is less than a full cylinder, the receiving portion 15 of backing member 14 will also be configured to be less than a full cylinder. Further, it is also contemplated that the retro-reflective surface 17 could be configured as one shape, such as a cylinder, and the rear surface 19 of the retro-reflective element 16 could be of a different shape to permit it to be attached to a backing member of a shape other than cylindrical.

The attachment portion 12 is configured to attach the insert 10 to another component, such as hollow member 22. Hollow member 22 may be a portion of a vehicle mounted bicycle rack (such as one of the pair of horizontal bars that extend along the length of a conventional automobile roof or trunk mounted bicycle rack). Or, hollow member 20 may be a part of another device, such as being the ends of the handlebars of a bicycle or tricycle. Additionally, other uses of the present insert are also contemplated, such as attaching the insert to the ends of a hollow member of any cross-section.

In the preferred embodiment, the diameter of the outer periphery of the attachment portion 12 is smaller than the corresponding diameter of the outer periphery of the retro-reflective element 16. Such a configuration enables the insert to be inserted into a hollow member such that the outer diameter of the retro-reflective element 16 is of essentially the same diameter as the outer periphery of the hollow member, thereby reducing wind resistance and creating an aesthetically pleasing flush appearance. Similarly, if the attachment portion and associated hollow member are not of a circular cross-section, the largest transverse dimension of the outer periphery of the attachment portion should preferably be smaller that the corresponding transverse dimension of the outer periphery of the retro-reflective element to also enable the same flush appearance with respect to the outer peripheral surfaces of the retro-reflective element and the hollow member that the insert is being inserted into.

In use, the attachment portion 12 of insert 10 is inserted into the hollow opening 24 of the hollow member 22. In order to help maintain the insert in position, one or more raised ribs 26 may optionally be provided on the outer peripheral surface of the attachment portion 12. Of course, other attachment configurations (such as bolting, adhesives, adhesive tape, and/or mounting to the external radial and/or axial peripheries of a tube or other member) are also contemplated as being within the scope of the invention.

It is contemplated that the present insert 10 may be provided as part of the original equipment of the device that it is attached to (such as a bicycle rack or handlebar), or that it may be an after-market device used to replace the original insert by removing the original insert and replacing it with the retro-reflective insert 10. In addition to improving the aesthetic appearance of its associated device, the present retro-reflective insert 10 could also improve the safety of the device that it is attached to by increasing the associated device's visible presence at night when the retro-reflective element 16 reflects a light (such as from an automobile's headlight or from a street light) towards an observer (such as a driver of an automobile).

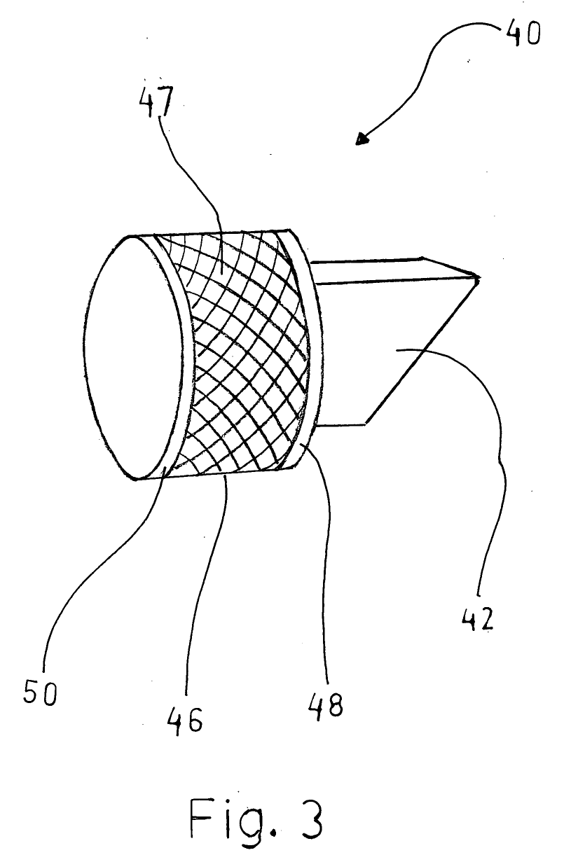

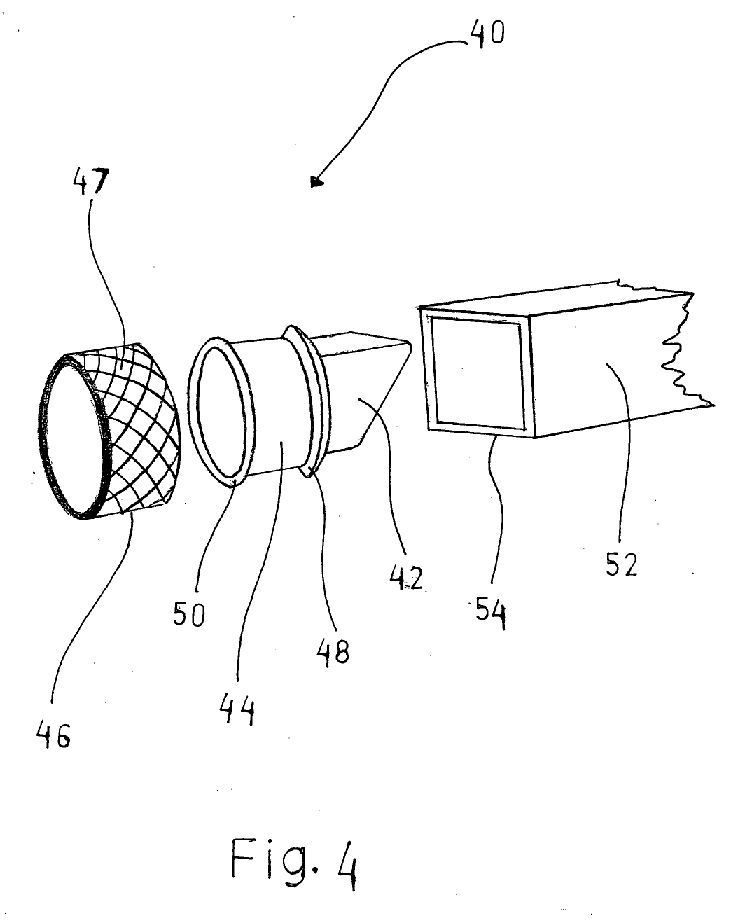

FIGS. 3 and 4 show another example of an embodiment of an insert, similar to that of FIGS. 1 and 2, except that the embodiment of FIGS. 3 and 4 is configured to be inserted into a hollow tube of generally rectangular cross-section (or, more particularly, of generally square cross-section), when the cross-section is taken transverse to the axial length. More specifically, FIGS. 3 and 4 show an insert 40 that includes an attachment portion 42 that is configured to be inserted into a hollow member 52 of a generally square cross-section that includes an opening 54 also of a generally square-shaped cross-section. Although an attachment portion of fully square cross-section (like a square version of attachment portion 12 of FIGS. 1 and 2, either with or without raised ribs 26) is contemplated as being within the scope of the invention, attachment portion 42 is preferably shaped like an angularly truncated box to facilitate insertion of the attachment portion 42 into the hollow opening 52. Of course, the box may be truncated at other angles and/or lengths from that shown in the figures. Additionally, the present invention can be configured to be inserted or attached to both hollow and non-hollow members of essentially any shape.

Referring back to FIGS. 3 and 4, the remainder of the elements of this embodiment (the backing member 44, the retro-reflective element 46, including the retro-reflective surface 47, and the lips 48 and 50 are essentially the same as the corresponding features of the embodiment of FIGS. 1 and 2. Accordingly, these features need not be discussed further, except to mention that variations these features may be varied, as desired, to customize the insert for a particular application.

Further, the retro-reflective element in this embodiment, as well as in all of the other embodiments, may be modified to take the form of a plurality of segments, each with a flat retro-reflecting surface, that are attached together to simulate a cylindrical surface or a portion of a cylindrical surface. Although such a device will not reflect light towards any angle, it will provide reflected light to a wider variety of angles than a single flat retro-reflecting surface.

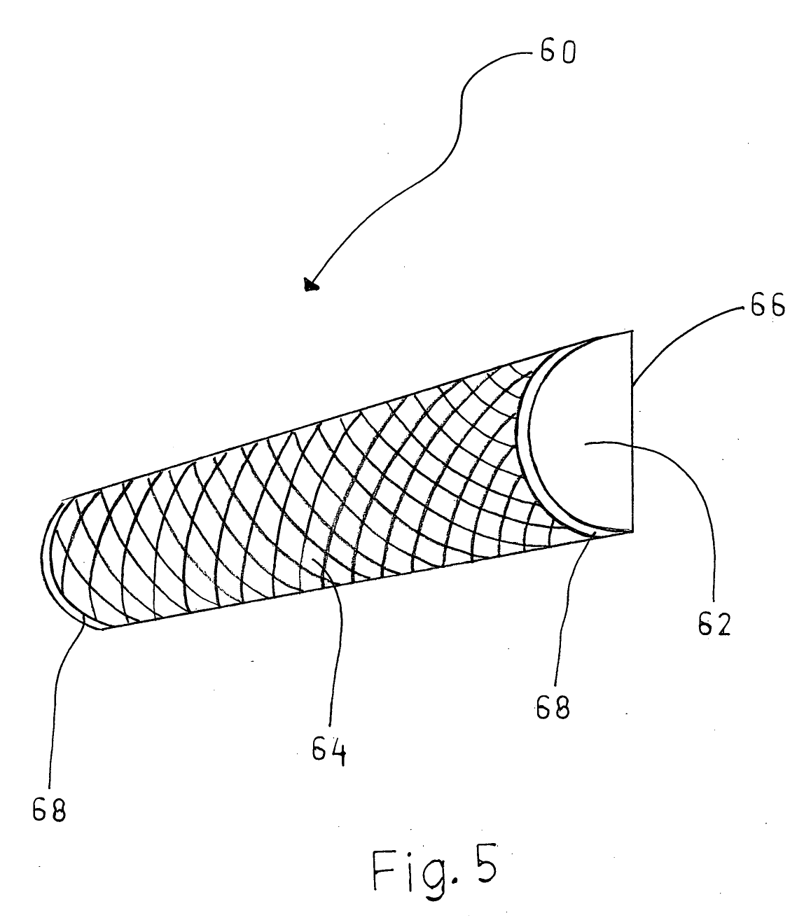

Turning now to FIGS. 5-7, another version of the present retro-reflective device will be shown and described. FIGS. 5-7 show different variations and uses of retro-reflective device 60.

FIG. 5 shows a semi-cylindrical configuration of retro-reflective device 60. As with the previously described embodiments, retro-reflective device 60 includes a relatively rigid backing member 62 (that may be, for example, made of rubber (or other similar elastomeric material), a plastic or a metal), and a retro-reflective element 64. Retro-reflective device 60 also preferable includes one, or more preferably a pair, of lips 68. Lip (or lips) 68 provide(s) one or more boundaries within which the retro-reflective element 64 may be seated.

Unlike the insert 10 and 40 of FIGS. 1-4, retro-reflective device 60 of FIGS. 5-7 does not include a configuration for inserting the device into another component. Instead, backing member 60 includes a mounting surface, such as surface 66, that is configured for mounting the device 60 upon a flat surface. Surface 66 may simply consist of a flat surface upon which an adhesive or double-sided adhesive tape is applied. Alternatively, surface 66 may include other arrangements suitable to facilitate mounting of the device upon another surface, such as a hole (or holes) configured to receive a hook (or hooks); projection(s) suitable to be inserted into mating aperture(s); one half of a hook and loop type fastening means (such as Velcro®); a threaded hole configured to receive a threaded rod; a threaded rod configured to be screwed into a threaded hole, etc.

The retro-reflective device 60 of FIG. 5 may be used in a variety of different applications. For example, device 60 may be applied to a wall (either interior or exterior) to act as a safety indicator. More specifically, device 60 could be affixed to an interior wall of a warehouse, for example, as a safety indicator. Or, for example, device 60 could be affixed to an exterior wall of a building situated in a parking lot to indicate to motorists the presence and location of such a wall by reflecting light from the vehicle's headlights back to the motorist.

Another possible use of retro-reflective device 60 is as a highway marker. If the retro-reflective device 60 is turned so that its mounting surface 66 faces downwardly, a plurality of the devices can be affixed to the highway surface at regular intervals to indicate, for example, lane boundaries or a safety message (such as by configuring the marker to spell out a word, such as “slow” or “stop”).

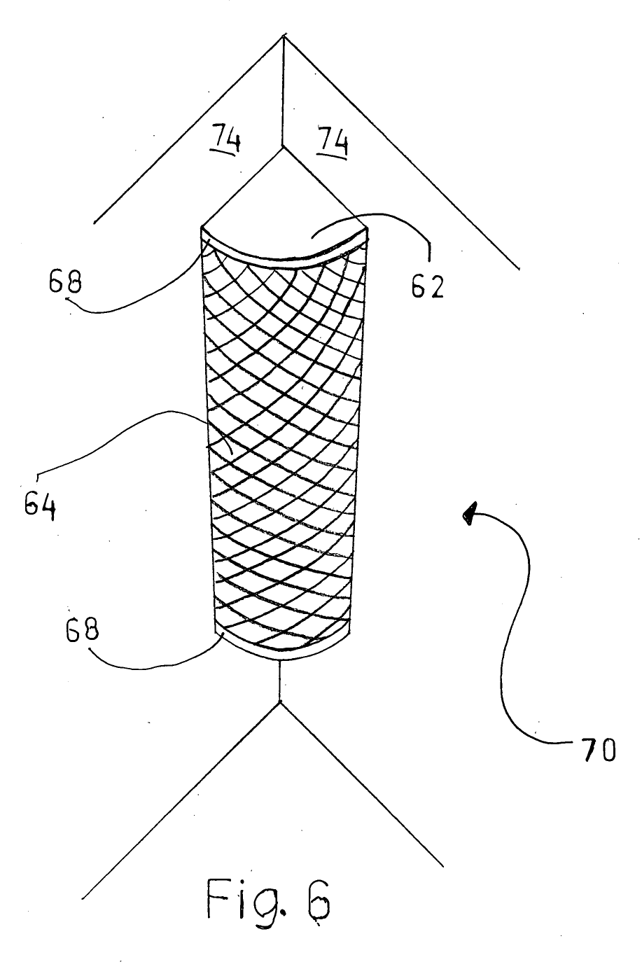

Although the example of the retro-reflective device shown in FIG. 5 is in the form of a half cylinder (i.e., of a 180° arc), the present invention may be made of any arcuate angle greater than 0°, up to and including 360°. For example, FIG. 6 shows a retro-reflective device 70, which encompasses a 90° arc. Other than the different arc dimension, retro-reflective device 70 of FIG. 6 includes the same components as device 60 of FIG. 5 (such as backing member 62, retro-reflective element 64 and optional lips 68). As shown in FIG. 6, the 90° arc configuration allows device 70 to be mounted to an interior corner, such as that shown between walls 72 and 74.

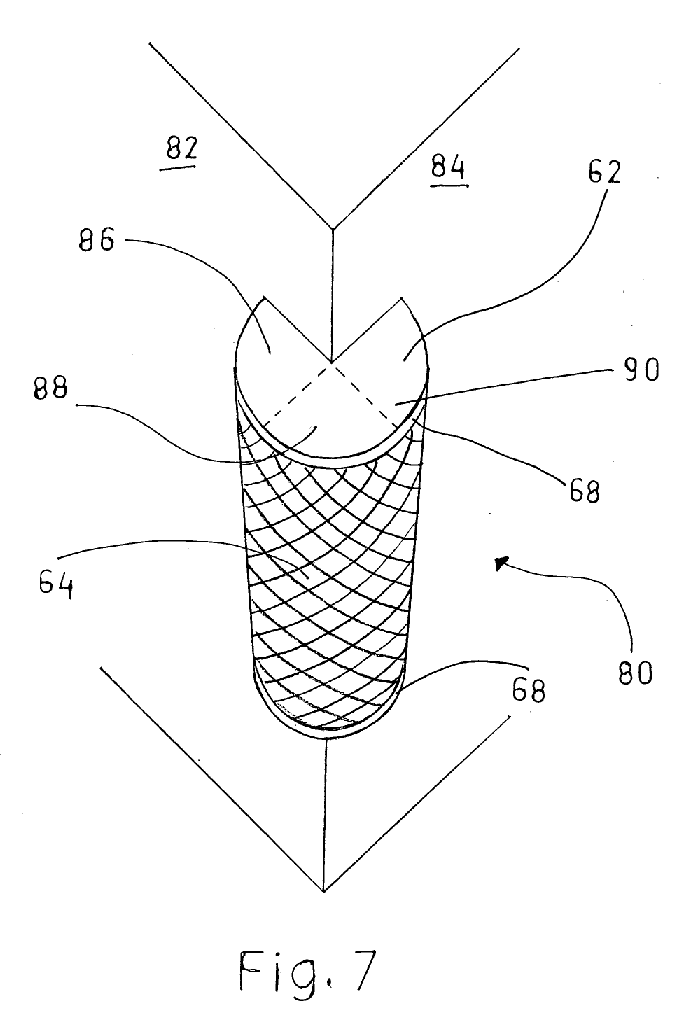

FIG. 7 shows another example of the present retro-reflective device, except this one encompasses 270°. Other than the different are dimension, retro-reflective device 80 of FIG. 7 includes the same components as devices 60 and 70 (such as backing member 62, retro-reflective element 64 and optional lips 68). As shown in FIG. 7, the 270° arc configuration allows device 80 to be mounted to an exterior corner, such as that shown between walls 82 and 84. Of course, this configuration, as well as the other configurations, can be made of any arcuate dimension to accommodate any desired application.

The retro-reflective device of the present invention may also comprise a system of retro-reflective segments that can be attached together for use as a retro-reflective device. For example, FIG. 7 shows, in dashed lines, how the device 80 can be comprised of three segments, 86, 88, 90, which are each of a 90° degree arc configuration. The three segments 86, 88, 90 can be attached to each other by any desired method, such as with an adhesive, a double-faced tape, a hook and loop attachment means (such as Velcro®), or by making any type of male/female connection. Of course, arcuate dimensions other than the 90° degree segments shown can be used and combined with each other as desired. One benefit of such a system is that a plurality of segments of a smaller arcuate dimension, such as 45° or 90°, can be packaged together as a kit, and then the purchaser can use the segments separately or attach them together in a variety of different ways to make the desired configuration. Alternatively, instead of including segments of only one or two arcuate dimensions, the kit could include segments of a variety of different arcuate dimensions, such as some 10° degree segments, some 30° segments, some 45° segments°, some 90° segments some 180° segments, and some 270° segments, which allows the purchaser greater freedom in creating the desired configuration. Once again, the arcuate angles mentioned above are only examples, and any desired arcuate angle greater than 0°, and up to 360°, may be used.

The FIG. 7 embodiment, as well as any of the other embodiments, could also be configured such that the surface of retro-reflective element 64 is formed of a plurality of flat segments that approximate a portion of cylindrical surface. For example, assuming that the FIG. 7 embodiment is divided into three segments, each of 90° (for a total of 270°), each segment could have a retro-reflective element with a relatively flat outer surface (of course, more than three segments could be utilized, which would better simulate an outer cylindrical surface). Such a device may be less expensive to manufacture than a device in which the outer surfaces of the retro-reflective elements are curved.

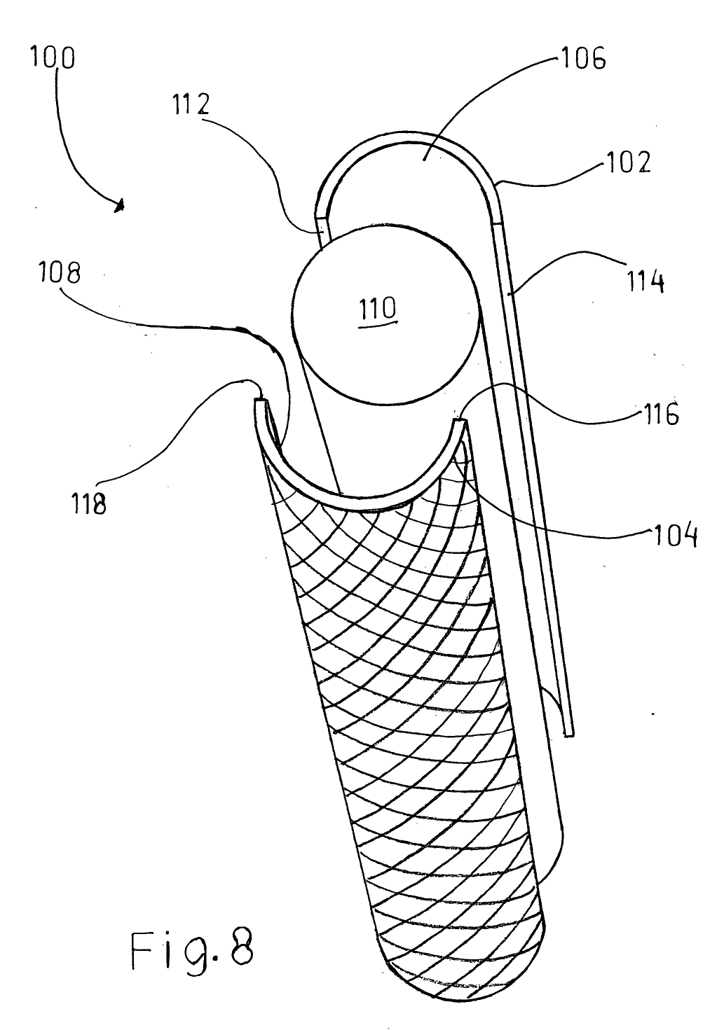

Turning now to FIG. 8, another embodiment of the present invention will be shown and discussed. The FIG. 8 embodiment of a retro-reflective device 100 includes two retro-reflective elements 102, 104, which preferably include, respectively, integrally formed backing members 106, 108. This embodiment is configured to be positioned upon a bar 110, such that when retro-reflective elements 106 and 108 are considered together, the retro-reflective surface is an approximately cylinder-shaped surface. The bar 110 may be any one of a variety of different applications, such as a portion of a bicycle or tricycle (handlebar, frame, etc.), one of the supports for a vehicular rear view mirror (such as those found on trucks), a portion of a baby carriage or stroller, etc.

In use, the two retro-reflective elements 102, 104 are attached to the bar 110, via an adhesive or any other desired attachment means, such that, when combined, they form a cylindrical retro-reflective outer surface. Either in addition to the adhesive, or as an alternative therefore, the axially extending side edges (112, 114, 116, 118) of the retro-reflective elements 102, 104 may include mating attachments means (such as cooperating male projections and female apertures) to attach the elements 102, 104 together. Or, it is also contemplated that other attachment means may also be utilized, such as simply wrapping a belt-like strap (including, for example, hook and loop attachment means (such as Velcro®) at the ends thereof) around the elements 102, 104 to attach them to the bar 110.

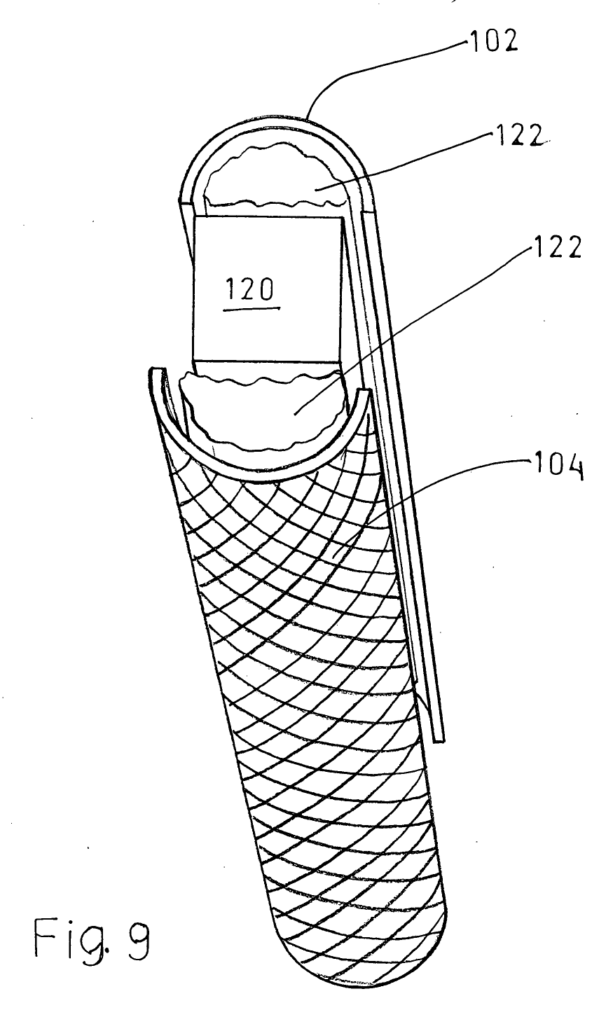

Turning now to FIG. 9, a variation on the FIG. 8 embodiment is shown. This embodiment is configured for attachment to a bar 120 of non-circular cross-section (although bar 120 is square, triangular bars or bars of any other shape may also be used with the present invention). The FIG. 9 embodiment is essentially the same as the FIG. 8 embodiment, except the FIG. 9 embodiment includes padding 122 to fill up the space between the outer periphery of the bar 120 and the inner periphery of the retro-reflective elements 102, 104. The padding 122 is preferably made of foam or other similar material that can conform to the shape of the outer periphery of bar 120. Instead of using padding 122, it is also contemplated that a relatively rigid backing member of the desired shape could also be used.

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A retro-reflective device comprising:
at least one relatively rigid backing member with a receiving portion shaped like at least a portion of a cylinder of a substantially uniform diameter; and
at least one retro-reflective element having a retro-reflecting surface facing outwardly and a rear surface facing inwardly, said rear surface of said retro-reflecting element being attached to said receiving portion of said at least one backing member,
wherein said retro-reflecting surface of said at least one retro-reflective element is at least partially approximately cylinder-shaped.

2. The retro-reflective device as defined in claim 1, further comprising a plurality of retro-reflective elements, similar in configuration to said at least one retro-reflective element, wherein said retro-reflecting surfaces of each of said retro-reflective elements are curved, and further wherein when all of said retro-reflective elements are in attached positions, said plurality of retro-reflecting surfaces form at least a portion of an approximately cylindrical-shaped surface.

3. The retro-reflective device as defined in claim 1, wherein said retro-reflecting surface is an approximately cylindrical-shaped surface.

4. The retro-reflective device as defined in claim 1, wherein said at least one backing member includes an axially extending hollow portion located radially interiorly of said receiving portion.

5. The retro-reflective device as defined in claim 1, wherein said at least one backing member is substantially solid.

6. The retro-reflective device as defined in claim 1, wherein the axial length of said backing member is equal to or greater than a corresponding axial length of said retro-reflective element attached thereto.

7. The retro-reflective device as defined in claim 1, wherein said backing member includes at least one lip extending around an axial end portion of said backing member.

8. The retro-reflective device as defined in claim 7, further comprising a second lip extending around the other axial end portion of said backing member, whereby said first lip and said second lip, together, surround said retro-reflecting surface.

9. A system of retro-reflective segments for use as a retro-reflective device, said system comprising:
a plurality of relatively rigid backing members, each of said backing members including a receiving portion shaped like at least a portion of a cylinder of a substantially uniform diameter, and
a plurality of retro-reflective elements, each having a retro-reflecting surface facing outwardly and with each of said retro-reflective elements being attached to said receiving portion of one of said backing members,
wherein said plurality of backing members are configured and arranged to be attached to each other such that an effective retro-reflecting surface defined by one or more of said retro-reflective elements forms at least a portion of an approximately cylindrical-shaped surface.

10 The system as defined in claim 9, wherein each of said retro-reflecting surfaces are configured and arranged to be positioned adjacent to each other such that said effective retro-reflecting surface is an approximately cylindrical-shaped surface.

11. The system as defined in claim 9, wherein each of said retro-reflecting surfaces is curved, such that when a plurality of said retro-reflective elements are positioned adjacent to each other, said effective retro-reflecting surface defines at least a portion of an approximately cylindrical-shaped surface.

12. The system as defined in claim 9, wherein each of said retro-reflective surfaces is generally flat, but when a plurality of said retro-reflective surfaces are positioned adjacent to each other, said effective retro-reflecting surface defines a surface that simulates at least a portion of a cylindrical-shaped surface.

13. The system as defined in claim 9, wherein at least two of said backing members are shaped with semi-circular interior portions, such that when said two backing members are attached to each other, a cylindrical area is defined that is configured to surround a bar with a generally cylindrical outer surface.

14. The system as defined in claim 13, wherein said bar is a component of a bicycle.

15. The system as defined in claim 13, wherein said bar is a component of a vehicular rear view mirror.

16. A retro-reflective insert comprising:
an attachment portion for attaching said insert to another component;
a relatively rigid backing member connected to said attachment portion; and
at least one retro-reflective element attached to an outer periphery of said backing member,
wherein the largest transverse dimension of the outer periphery of said attachment portion is a smaller than the corresponding transverse dimension of the outer periphery of said retro-reflective element.

17. The insert as defined in claim 16, wherein said retro-reflective member substantially surrounds said backing member.

18. The insert as defined in claim 17, wherein said attachment portion is configured as a full cylinder.

19. The insert as defined in claim 17, wherein at least a portion of said attachment portion is generally rectangular-shaped when considered in cross-section taken transverse to an axial length.

20. The insert as defined in claim 16, wherein said attachment portion includes at least one raised rib on an outer periphery thereof.

21. The insert as defined in claim 16, wherein said backing member includes a pair of spaced apart lips on an outer periphery thereof, and further wherein said retro-reflective element is positioned between said lips.

22. The insert as defined in claim 16, wherein said attachment portion is configured and arranged to be inserted into a hollow member of a bicycle rack configured and arranged to be attached to a motor.
